(19) United States
(12) Patent Application Publication
(10) Pub. No.: US 2001/0032952 A1
(43) Pub. Date: Oct. 25, 2001

(54) Floating stuffing box assembly

(76) Inventor: Ruben Lah, West Jordan, UT (US)

Correspondence Address: Michael F. Krieger, KIRTON & McCONKIE, 1800 Eagle Gate Tower, 60 East South Temple, Salt Lake City, UT, 84111, US

(21) Appl. No.: 09/759,969

(22) Filed: Jan. 12, 2001

Related U.S. Application Data
(60) Provisional application No. 60/176,270, filed on Jan. 14, 2000.

(51) Int. Cl. F16K 41/02

(52) U.S. Cl. 251/214

(57) ABSTRACT

A floating stuffing box is disclosed which prevents leakage caused by oscillation of the valve stem compressing packing material by instead allowing for movement of the ball within the socket of the base wall as lateral movement of the base.

### RELATED APPLICATIONS

This application claims priority to provisional application Ser. No. 60/176,270, filed Jan. 14, 2000.

### BACKGROUND OF THE INVENTION

1. Field of the Invention

This invention relates generally to a stuffing box valve assembly and in particular to a floating stuffing box assembly which prevents oscillation of the valve stem from deforming the packing and causing leaks.

2. Background

In the past, packing gland assemblies have been designed to allow rotational movement of the stem within the body while preventing bypass of fluids along the stem through the body. Problems develop, however, when the movement of the stem is not merely rotational, but also involves an oscillation or bending of the stem causing the packing on one side of the stem to be compressed and relieving the pressure on the packing on the opposite side of the stem allowing leaking by the stem to occur. If this oscillation is continued, the packing will fail and leakage will occur along the stem.

### SUMMARY AND OBJECTS OF THE INVENTION

It is an object of some embodiments of the present invention to provide a floating stuffing box assembly which permits some oscillation of the valve stem to occur without damaging the packing around the stem.

The invention comprises two main features which work together to implement the technology. The first feature is a packing gland body having a spherical end which is held in place in a base by a retainer. The base has a socket formed within it which corresponds to the shape of the ball on the end of the packing gland body. The ball and socket relationship allows the packing gland to move within the base without causing added pressure to be placed upon the packing surrounding the valve stem. Within the ball of the gland body is a guide bushing which forces the base to move laterally when the stem oscillates. This lateral movement is the second feature.

### BRIEF DESCRIPTION OF THE DRAWINGS

In order that the manner in which the above-recited and other advantages and objects of the invention are obtained, a more particular description of the invention briefly depicted above will be rendered by reference to a specific embodiment thereof which is illustrated in the appended drawings. With the understanding that these drawings depict only a typical embodiment of the invention and are not therefore to be considered to be limiting of its scope, the invention will be described and explained with additional specificity and detail through the use of the accompanying drawings in which:

FIG. 1 is a cross-sectional elevational view of one embodiment of the present invention.

### DETAILED DESCRIPTION OF THE PREFERRED EMBODIMENTS

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

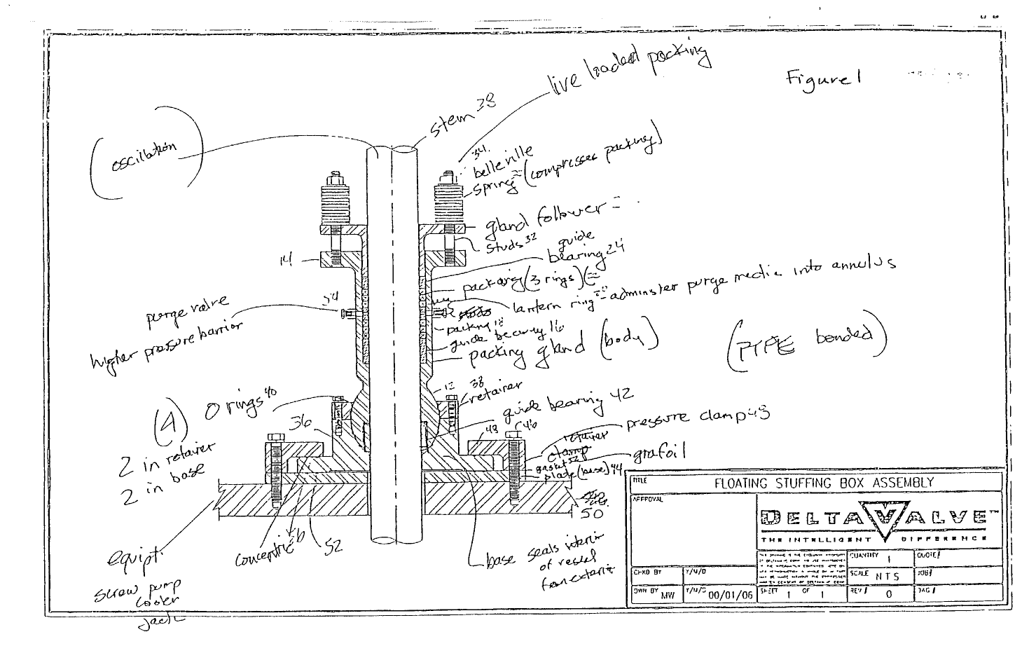

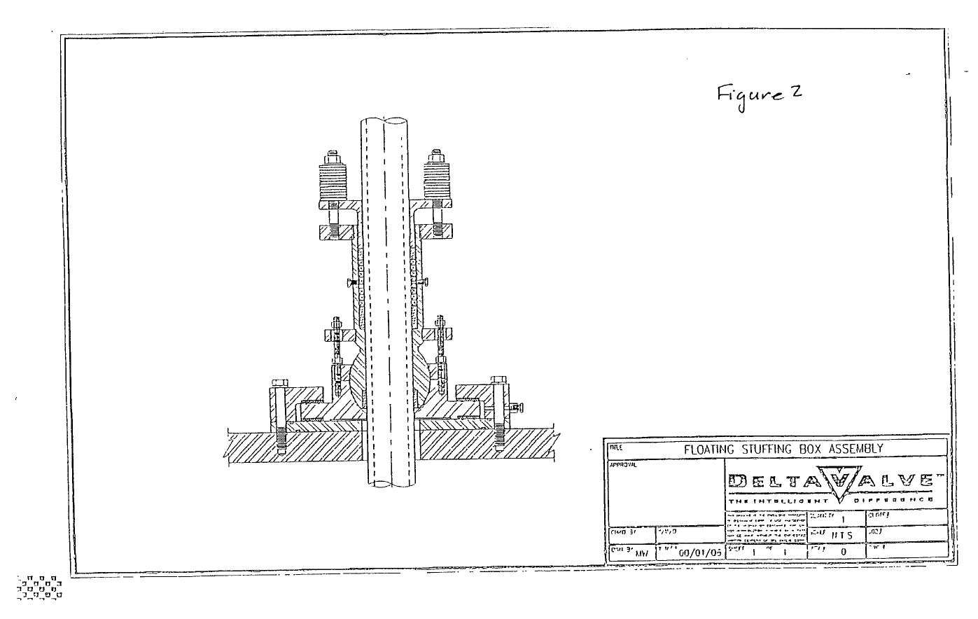

As seen in FIG. 1, one embodiment of the present invention utilizes a ball and socket arrangement to obviate the stresses on the packing around the valve stem when the valve stem oscillates. The valve assembly consists of a packing gland body 10 having a spherical portion 12 and an upper L-shaped portion 14. Located within packing gland body 10 is a guide bearing 16, packing 18, a lateraling 20, three additional rings of packing 22, a guide bearing 24, and at the very top of the packing gland a gland follower 26. The bearings and packing allow for rotational movement of the valve stem 28 within packing gland body 10. It will be appreciated that valve stem 28 can also be a shaft or stem going to equipment.

To maintain pressure upon the packing, bearings, lantern ring, gland follower 26 is biased in a downward direction by a Belleville spring 30, stud 32 and nut 34. Nut 34 compresses Belleville spring 30 thereby urging gland follower 26 downward to apply pressure to the packing and guide bearings beneath the gland follower within packing gland body 10.

Packing gland body 10 is held to a base 36 by a retainer 38. Retainer 38 is bolted to base 36 to retain packing gland body 10. “O” rings 40 are located about the ball-shaped portion of the packing gland to prevent the flow of fluid through the space between the ball and socket. In the preferred embodiment illustrated in FIG. 1, four “O” rings are provided for this purpose. A guide bearing 42 is also located within the ball-shaped portion of the packing gland to guide the lateral movement of the packing gland body 10 and base 36 during rotational movement.

It will be appreciated that gaskets, “O” rings, seals, and the use of materials such as PTFE as is known in the industry will be utilized during the construction of the elements of the base to provide additional protection from leakage. Base 36 is retained against a base plate 44 by a bolt 46 which passes through a pressure clamp 48 which is L-shaped. Bolt 46 passes through pressure clamp 48 and base plate 44 and penetrates into equipment 50. A gasket 52 may be placed in between the pressure clamp and the base plate. Additional leakage protection is provided by concentric “O” rings 52 to prevent leakage around the base of the valve assembly. Additional protection is provided by applying positive pressure through a purge valve 54 into lantern ring 20. The pressure is regulated such that it will overcome any pressure from fluid attempting to bypass lantern ring 20. As a result, a stream of air will be introduced into the flow of fluid instead of fluid exiting the valve assembly. A similar system is used for purge valve 56 at the low end of the valve assembly.

What is claimed is:

1. A floating stuffing box assembly comprising:
a) a packing gland body having a ball-shaped end;
b) a base assembly having a socket formed therein;
c) a valve stem passing through the packing gland body and the base portion, voscillation of the valve stem being translated into movement of the ball-shaped end of the packing gland within the socket of the base.
